(19) United States
(12) Patent Application Publication
(10) Pub. No.: US 2008/0305826 A1
(43) Pub. Date: Dec. 11, 2008

(54) Communication Device

(75) Inventors: Junichi Morita, Tokyo (JP); Toshio Oka, Kanagawa (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/571,795

(22) PCT Filed: Jul. 6, 2005
(86) PCT No.: PCT/JP05/12493

§ 371 Date: Jan. 8, 2007

(30) Foreign Application Priority Data
Jul. 7, 2004 (JP) 2004-200301
Jul. 6, 2005 (JP) 2005-197191

(51) Int. Cl. H04M 1/00

(52) U.S. Cl. 455/556.1

(57) ABSTRACT

It is equipped with information inquiry means which inquires for service utilization information regarding user's utilization of network on the occasion of receiving a multimedia transmission service by communication server through network, circuit switch communication means and packet switch communication means which communicate with communication server accounting situation monitor means which monitors a use situation of each communication means and, and multimedia transmission service request means which requests for a multimedia transmission service by communication server, on the basis of service utilization information acquired by information inquiry means and result information monitored by accounting situation monitor means, and can receive an optimum multimedia transmission service, responsive to a utilization situation of each communication means.

### TECHNICAL FIELD

This invention relates to a communication apparatus such as a communication terminal and a communication server, for carrying out reception of a multimedia transmission service and interactive communication with another communication terminal, responsive to changes of user's subscription situation, accounting situation, etc. for a carrier service.

### BACKGROUND ART

In recent years, along with the progress in performance of portable telephones, it has been remarkable that various multimedia transmission services by various bearers (e.g. a video streaming service, an audio streaming service, etc.) become available, and it is presumed that it will be escalated more and more.

In the past, in most cases of receiving a multimedia transmission service by a portable telephone, a user specifies a service, and in addition, for a user to change a multimedia transmission service during receiving, what was used is a method of specifying a new service after terminating the service or interrupting the service.

Further, in the past, as a method of providing an optimum service to a user out of various communication services, a system of requesting a call by automatically selecting the cheapest communication line out of communication services to which a user subscribes, like ACR (Automatic Carrier Routing), and a scheme of registering a user's desired terms in advance and selecting a line which has matched with the terms at calling, as described in Japanese Patent Unexamined Publication No. 2003-92622, have been disclosed.

On the one hand, in a world of portable telephones, it is in a transition stage from PDC (Personal Digital Cellular) which is 2G wireless system to W-CDMA (Wideband-Code Division Multiple Access) or CDMA2000 which is 3G wireless system. Each carrier has prepared price plans for W-CDMA and CDMA2000 in addition to PDC, and has newly set up a packet price plan, a packet fixed price plan and so on, and it is presumed that price plans have become diversified more and more, on the occasion that a transition to 3G goes into full swing.

However, by the above-described methods, it is not possible to provide an optimum multimedia transmission service to each of all users who come into price plans which are projected to become diversified more and more.

Concretely speaking, a case in which a user, who has come into a packet fixed price system, receives a multimedia transmission service by circuit switch, and a case in which an amount charged to a user becomes huge due to the price system not coped with a time-varying accounting situation (e.g., such a situation that an accounting coefficient increases when an account exceeds a certain threshold value, etc.) existed.

Further, also even in case that a communication terminal can provide multimedia transmission services, it is not always possible to provide an optimum service to every user having a reception terminal for multimedia transmission services, and in addition, in case that accounting, caused by network use, is also generated on a service provider side, it is presumed to happen that each user having a service providing terminal can not be provided an optimum service and an amount charged to the user becomes huge.

Furthermore, also in talking between communication terminals, it happens that it is not possible to select an optimum communication bearer for a user of a calling terminal in case of calling side accounting, and for a user of an incoming terminal in case of incoming side accounting and an amount charged to a user becomes huge.

### DISCLOSURE OF THE INVENTION

The present invention is made in view of above-mentioned points, and aims to provide a communication apparatus such as a communication terminal and a communication server, which carries out reception of a multimedia transmission service and interactive communication with another communication terminal, responsive to a change of a user's subscription situation, an accounting situation and so on, for a carrier service which diversified users subscribe to.

A communication apparatus of the present invention has a configuration equipped with a service utilization information procurement section which procures service utilization information regarding user's utilization of a communication medium, on the occasion of receiving provision of a multimedia transmission service through a communication medium, a communication section which carries out communication with a multimedia transmission service providing device that provides multimedia transmission services through the communication medium, a communication situation monitor section which monitors a use situation of the communication section, and a multimedia transmission service request section which requests for provision of a multimedia transmission service to the multimedia transmission service providing device, on the basis of service utilization information procured by the service utilization information procurement section or result information monitored by the communication monitor section.

By this configuration, it becomes possible for the communication situation monitor section to sequentially get hold of a use situation of the communication section which changes dynamically, and it becomes possible to select an optimum multimedia transmission service, out of multimedia transmission services by various bearers which are provided by a multimedia transmission service provider etc., on the basis of user's subscribed service utilization information.

In addition, a communication apparatus of the present invention has such a configuration that the multimedia transmission service providing device has a user information management server which manages service utilization information regarding user's utilization of a communication medium and supplies the service utilization information to the service utilization information procurement section, and a communication server which carries out provision of a multimedia transmission service, responsive to a request from the multimedia transmission service request section.

By this configuration, it becomes possible for the communication situation monitor section to sequentially get hold of a use situation of the communication section which changes dynamically, and it becomes possible to select an optimum multimedia transmission service, out of multimedia transmission services by various bearers which are provided by a communication server owned by a multimedia transmission service provider etc., on the basis of user's subscribed service utilization information which is managed by the user information management server.

In addition, a communication apparatus of the present invention has such a configuration that the multimedia transmission service providing device has a user information management server which manages service utilization information regarding user's utilization of a communication medium and supplies the service utilization information to the service utilization information procurement section, and another communication device which carries out provision of a multimedia transmission service, responsive to a request from the multimedia transmission service request section.

By this configuration, it becomes possible for the communication situation monitor section to sequentially get hold of a use situation of the communication section which changes dynamically, and it becomes possible to select an optimum multimedia transmission service, out of multimedia transmission services by various bearers which are provided by another communication device owned by an individual who provides multimedia transmission services, on the basis of user's subscribed service utilization information which is managed by the user information management server.

In addition, a communication apparatus of the present invention has such a configuration that the communication section has a packet switch communication section which is coupled to a communication medium and carries out communication by packet switch, and a circuit switch communication section which is coupled to the communication medium and carries out communication by circuit switch.

By this configuration, it becomes possible for the communication situation monitor section to sequentially get hold of a use situation of the packet switch communication section and the circuit switch communication section which change dynamically, and it becomes possible to select an optimum multimedia transmission service, out of multimedia transmission services by various bearers which are provided by a multimedia transmission service provider, on the basis of user's subscribed service utilization information.

In addition, a communication apparatus of the present invention has such a configuration that the communication situation monitor section monitors an accounting situation which arises from use of the packet switch communication section or the circuit switch communication section, or a packet use situation which arises from use of the packet switch communication section.

By this configuration, it becomes possible for the communication situation monitor section to sequentially get hold of an accounting situation and a packet use situation which change dynamically, and it becomes possible to select an optimum multimedia transmission service, out of multimedia transmission services by various bearers which are provided by a multimedia transmission service provider, on the basis of user's subscribed service utilization information.

In addition, a communication apparatus of the present invention has such a configuration that the service utilization information is an accounting situation or a packet use situation of a user.

By this configuration, it becomes possible for a communication terminal to sequentially get hold of an accounting situation and a packet use situation which change dynamically, and it becomes possible to select or change to an optimum multimedia transmission service, out of multimedia transmission services by various bearers which are provided by a multimedia transmission service provider, on the basis of user's subscribed service utilization information, current accounts and packet integrated value.

Further, a communication apparatus of the present invention has a configuration equipped with a multimedia transmission method deciding section which decides a multimedia transmission method, i.e. a method of providing a multimedia transmission service, on the basis of a multimedia transmission service request from another communication apparatus which requests for provision of a multimedia transmission service, a multimedia transmission section which transmits the requested multimedia transmission service to another communication apparatus through a communication medium by a multimedia transmission method which is decided by the multimedia transmission method deciding section, and a communication section which carries out communication with another communication apparatus through the communication medium.

By this configuration, it becomes possible to select an optimum multimedia transmission service, out of multimedia transmission services by various bearers, which are provided by a multimedia transmission service provider, on the basis of a multimedia transmission service request from another communication apparatus.

In addition, a communication apparatus of the present invention has such a configuration that the multimedia transmission service request from another communication apparatus includes a request for changing a method of providing a multimedia transmission service, which is requested, responsive to a use situation of a communication section in another communication apparatus.

By this configuration, it is possible for another communication apparatus to sequentially get hold of a use situation of the communication section of another communication apparatus which changes dynamically, and to provide a multimedia transmission service, according to a request for providing a multimedia transmission service which corresponds to the result of the use situation.

In addition, a communication apparatus of the present invention has such a configuration that the multimedia transmission section has a transmission information storage section which stores transmission information to be transmitted, and transmission information, which has stored in the information storage section, is transmitted to another communication apparatus through a communication section and a communication medium.

By this configuration, it is possible to transmit transmission information, which has been stored in the information storage section, to another communication apparatus, on the basis of a multimedia transmission service request from another communication apparatus.

In addition, a communication apparatus of the present invention has such a configuration that the communication section has a packet switch communication section which is coupled to a communication medium and carries out communication by packet switch, and a circuit switch communication section which is coupled to the communication medium and carries out communication by circuit switch.

By this configuration, it is possible for another communication apparatus to sequentially get hold of a use situation, by use of packet switch and circuit switch of the communication section both of which change dynamically, and provide a multimedia transmission service, according to a request for providing a multimedia transmission service which corresponds to the result of the use situation.

In addition, a communication apparatus of the present invention has such a configuration that another communication apparatus has a communication situation monitor section that monitors a use situation of a communication section of another communication apparatus, and a multimedia transmission service request is carried out, responsive to result information monitored by the communication situation monitor section.

By this configuration, it becomes possible for the communication situation monitor section to sequentially get hold of a use situation of the communication section of another communication apparatus which changes dynamically, and it becomes possible to select an optimum multimedia transmission service, out of multimedia transmission services by various bearers which are provided by a multimedia transmission service provider, responsive to a request from the multimedia transmission service request section.

In addition, a communication apparatus of the present invention has such a configuration that another communication apparatus has a service utilization information procurement section that procures service utilization information regarding user's utilization of a communication medium, on the occasion of receiving provision of a multimedia transmission service through the communication medium, and a multimedia transmission service request is carried out, on the basis of the service utilization information which is procured by the service utilization information procurement section.

By this configuration, it becomes possible for a communication terminal to sequentially get hold of a use situation of the communication section of another communication apparatus which changes dynamically, and it becomes possible to select an optimum multimedia transmission service, out of multimedia transmission services by various bearers which are provided by a multimedia transmission service provider, on the basis of user's subscribed service utilization information.

In addition, a communication apparatus of the present invention has such a configuration that the communication section of another communication apparatus has a packet switch communication section which is coupled to a communication medium and carries out communication by packet switch, and a circuit switch communication section which is coupled to the communication medium and carries out communication by circuit switch.

By this configuration, it becomes possible for another communication apparatus to sequentially get hold of a dynamically changing use situation of the packet switch communication section and the circuit switch communication section which are the communication sections of another communication apparatus, and it becomes possible to select an optimum multimedia transmission service, out of multimedia transmission services by various bearers which are provided by a multimedia transmission service provider, responsive to a request from the multimedia transmission service request section.

In addition, a communication apparatus of the present invention has such a configuration that the communication section of another communication apparatus has a packet switch communication section which is coupled to a communication medium and carries out communication by packet switch, and a circuit switch communication section which is coupled to the communication medium and carries out communication by circuit switch, and the communication situation monitor section monitors an accounting situation which arises from use of the 4 packet switch communication section or the circuit switch communication section, or a packet use situation which arises from use of the packet switch communication section.

By this configuration, it becomes possible for the communication situation monitor section to sequentially get hold of an accounting situation and a packet use situation both of which change dynamically, and it becomes possible to select an optimum multimedia transmission service, out of multimedia transmission services by various bearers which are provided by a multimedia transmission service provider, responsive to a request from the multimedia transmission service request section.

In addition, a communication apparatus of the present invention has such a configuration that the communication section of another communication apparatus has a packet switch communication section which is coupled to a communication medium and carries out communication by packet switch, and a circuit switch communication section which is coupled to the communication medium and carries out communication by circuit switch, and the communication situation monitor section monitors an accounting situation which arises from use of the packet switch communication section or the circuit switch communication section, or a packet use situation which arises from use of the packet switch communication section, and the service utilization information is an accounting situation or a packet use situation of a user.

By this configuration, it becomes possible for the communication situation monitor section to sequentially get hold of an accounting situation and a packet use situation both of which change dynamically, and it becomes possible to select an optimum multimedia transmission service, out of multimedia transmission services by various bearers which are provided by a multimedia transmission service provider, on the basis of user's current accounting situation and packet situation.

Further, a communication apparatus of the present invention has a configuration equipped with a service utilization information procurement section which procures service utilization information regarding user's utilization of a communication medium, on the occasion of providing a multimedia transmission service to another communication apparatus through a communication medium, a communication section which carries out communication with another communication apparatus through the communication medium, a communication situation monitor section which monitors a use situation of the communication section, a multimedia transmission method deciding section which decides a method of providing a multimedia transmission service, on the occasion of providing a multimedia transmission service to another communication apparatus, and a multimedia transmission service change request section which requests for a change of the method of providing a multimedia transmission service, to another communication apparatus, on the basis of result information monitored by the communication situation monitor section.

By this configuration, it becomes possible for the communication situation monitor section to sequentially get hold of a use situation of the communication section which changes dynamically, and it becomes possible to select an optimum multimedia transmission service, out of multimedia transmission services by various bearers which are provided on the basis of user's subscribed service utilization information.

In addition, a communication apparatus of the present invention has such a configuration that the communication section has a packet switch communication section which is coupled to a communication medium and carries out communication by packet switch, and a circuit switch communication section which is coupled to the communication medium and carries out communication by circuit switch.

By this configuration, it becomes possible for the communication situation monitor section to sequentially get hold of dynamically changing situations of the packet switch communication section and the circuit switch communication section, and it becomes possible to select an optimum multimedia transmission service, out of multimedia transmission services by various bearers which are provided, on the basis of user's subscribed service utilization information.

In addition, a communication apparatus of the present invention has such a configuration that the communication situation monitor section monitors an accounting situation which arises from use of the packet switch communication section or the circuit switch communication section, or a packet use situation which arises from use of the packet switch communication section.

By this configuration, it becomes possible for the communication situation monitor section to sequentially get hold of an accounting situation and a packet use situation both of which change dynamically, and it becomes possible to select an optimum multimedia transmission service, out of multimedia transmission services by various bearers which are provided, on the basis of user's subscribed service utilization information.

In addition, a communication apparatus of the present invention has such a configuration that the service utilization information is an accounting situation or a packet use situation of a user.

By this configuration, it becomes possible for a communication terminal to sequentially get hold of an accounting situation and a packet use situation both of which change dynamically, and it becomes possible to select or change to an optimum multimedia transmission service, out of multimedia transmission services by various bearers which are provided, on the basis of user's subscribed service utilization information, current accounts and packet integration values.

Further, a communication apparatus of the present invention has a configuration equipped with a service utilization information procurement section which procures service utilization information regarding user's utilization of a communication medium, on the occasion of receiving provision of a multimedia transmission service through the communication medium, a multimedia transmission service request condition preparing section which prepares a request condition of a multimedia transmission service which is provided, on the basis of service utilization information procured by the service utilization information procurement section, a multimedia transmission service request section which transmits the request condition prepared by the multimedia transmission service condition preparing section to another communication apparatus which provides a multimedia transmission service, and a communication section which carries out communication with another communication apparatus through the communication medium.

By this configuration, it is possible to prepare a request condition of a multimedia transmission service on the basis of a use situation of the communication section which changes dynamically, and it becomes possible to select an optimum multimedia transmission service, out of multimedia transmission services by various bearers which are provided by a multimedia transmission service provider, on the basis of user's subscribed service utilization information.

In addition, a communication apparatus of the present invention has such a configuration that the communication section has a packet switch communication section which is coupled to a communication medium and carries out communication by packet switch, and a circuit switch communication section which is coupled to the communication medium and carries out communication by circuit switch.

By this configuration, the multimedia transmission service request condition preparing section can prepare a multimedia transmission service request condition, on the basis of a result of sequentially getting hold of use situations of the packet switch communication section and the circuit switch communication section both of which change dynamically, and it becomes possible to select an optimum multimedia transmission service, out of multimedia transmission services by various bearers which are provided by a multimedia transmission service provider, on the basis of user's subscribed service utilization information.

In addition, a communication apparatus of the present invention has such a configuration that another communication apparatus monitors an accounting situation, which arises from use of the packet switch communication section or the circuit switch communication section, or a packet use situation which arises from use of the packet switch communication section.

By this configuration, it becomes possible for another communication apparatus to sequentially get hold of an accounting situation and a packet use situation both of which change dynamically, and it becomes possible to select an optimum multimedia transmission service, out of multimedia transmission services by various bearers which are provided by a multimedia transmission service provider, on the basis of user's subscribed service utilization information.

In addition, a communication apparatus of the present invention has such a configuration that the service utilization information is an accounting situation or a packet use situation of a user.

By this configuration, it becomes possible for another communication apparatus to sequentially get hold of an accounting situation and a packet use situation both of which change dynamically, and it becomes possible to select or change an optimum multimedia transmission service, out of multimedia transmission services by various bearers which are provided by a multimedia transmission service provider, on the basis of user's subscribed service utilization information, current accounts and packet integration values.

Further, a communication apparatus of the present invention has a configuration equipped with a multimedia transmission method deciding section which decides a method of providing a multimedia transmission service, on the basis of a multimedia transmission service request from another communication apparatus which requests for provision of a multimedia transmission service, a multimedia transmission section which transmits the requested transmission information, to another communication apparatus, through a communication medium, by a multimedia transmission method decided by the multimedia transmission method deciding section, a communication section which carries out communication with another communication apparatus through the communication medium, a communication situation monitor section which monitors a use situation of the communication section, and a multimedia transmission method changing section which changes a method of providing a multimedia transmission service, responsive to a multimedia transmission service request, prepared on the basis of result information monitored by the communication situation monitor section.

By this configuration, it becomes possible for the communication situation monitor section to sequentially get hold of a use situation of the communication section which changes dynamically, and it becomes possible to select an optimum multimedia transmission service, out of multimedia transmission services by various bearers which are provided by a multimedia transmission service provider, on the basis of a multimedia transmission service request prepared by a result information monitored by the communication situation monitor section.

In addition, a communication apparatus of the present invention has such a configuration that the communication section has a packet switch communication section which is coupled to a communication medium and carries out communication by packet switch, and a circuit switch communication section which is coupled to the communication medium and carries out communication by circuit switch.

By this configuration, it becomes possible for the communication situation monitor section to sequentially get hold of use situations of the packet switch communication section and the circuit switch communication section both of which change dynamically, and it becomes possible to select an optimum multimedia transmission service, out of multimedia transmission services by various bearers which are provided by a multimedia transmission service provider, on the basis of a multimedia transmission service request prepared by result information monitored by the communication situation monitor section.

In addition, a communication apparatus of the present invention has such a configuration that the communication situation monitor section monitors an accounting situation which arises from use of the packet switch communication section or the circuit switch communication section, or a packet use situation which arises from use of the packet switch communication section.

By this configuration, it becomes possible for the communication situation monitor section to sequentially get hold of an accounting situation and a packet use situation both of which change dynamically, and it becomes possible to select an optimum multimedia transmission service, out of multimedia transmission services by various bearers which are provided by a multimedia transmission service provider, on the basis of a multimedia transmission service request prepared by result information monitored by the communication situation monitor section.

In addition, a communication apparatus of the present invention has such a configuration that another communication apparatus has a service utilization information procurement section which procures service utilization information regarding user's utilization of a communication medium, on the occasion of receiving provision of a multimedia transmission service through a communication medium, and a multimedia transmission service request is requested, on the basis of service utilization information procured by the service utilization information procurement section.

By this configuration, it becomes possible for the communication situation monitor section to sequentially get hold of a use situation of the communication section which changes dynamically, and it becomes possible to select an optimum multimedia transmission service, out of multimedia transmission services by various bearers which are provided by a multimedia transmission service provider, responsive to service utilization information which another communication apparatus procures by the service utilization information procurement section and a multimedia transmission service request prepared by result information monitored by the communication situation monitor section.

In addition, a communication apparatus of the present invention has such a configuration that the communication section has a packet switch communication section which is coupled to a communication medium and carries out communication by packet switch, and a circuit switch communication section which is coupled to the communication medium and carries out communication by circuit switch, and the communication situation monitor section monitors an accounting situation which arises from use of the packet switch communication section or the circuit switch communication section, or a packet use situation which arises from use of the packet switch communication section, and the service utilization information is an accounting situation or a packet use situation of a user.

By this configuration, it becomes possible for the communication situation monitor section to sequentially get hold of an accounting situation and a packet use situation both of which change dynamically, and it becomes possible to select or change to an optimum multimedia transmission service, out of multimedia transmission services by various bearers which are provided by a multimedia transmission service provider, responsive to a multimedia transmission service request prepared on the basis of user's subscribed service utilization information, current accounts and packet integration values.

As above, the present invention can provide a communication apparatus such as a communication terminal and a communication server, which carries out reception of an optimum multimedia transmission service and interactive communication with another communication terminal, responsive to changes of a carrier service subscription situation and an accounting situation of every one of diversified users.

### BRIEF DESCRIPTION OF THE DRAWINGS

FIG. 1 is a block diagram which shows a configuration of a communication system that relates to embodiment 1 of the present invention.

FIG. 2A is a sequence chart for explaining an operation of the communication system which relates to embodiment 1 of the present invention.

FIG. 2B is another sequence chart for explaining an operation of the communication system which relates to embodiment 1 of the present invention.

FIG. 3A is a data format view shows conditions for carrying out a service request or a change request of a video transmission service, which relates to embodiment 1 and embodiment 2 of the present invention.

FIG. 3B is another data format view which shows conditions for carrying out a service request or a change request of a video transmission service, which relates to embodiment 1 and embodiment 2 of the present invention.

FIG. 4 is a block diagram which shows a configuration of a communication system that relates to embodiment 2 of the present invention.

FIG. 5A is a sequence chart for explaining an operation of the communication system which relates to embodiment 2 of the present invention.

FIG. 5B is another sequence chart for explaining an operation of the communication system which relates to embodiment 2 of the present invention.

FIG. 6 is a block diagram which shows a configuration of a communication system that relates to embodiment 3 of the present invention.

FIG. 7 is a sequence chart for explaining an operation of the communication system which relates to embodiment 3 of the present invention.

FIG. 8A is a data format view which shows video transmission service change requirements given to a video transmission service request that relates to embodiment 3 of the present invention.

FIG. 8B is another data format view which shows video transmission service change requirements given to a video transmission service request that relates to embodiment 3 of the present invention.

### DESCRIPTION OF REFERENCE NUMERALS AND SIGNS

101, 601 communication terminal
102 communication terminal overall control means
103, 408 subscribed service utilization information inquiry means
104 multimedia transmission service request means
105 accounting situation monitor means
106 packet situation monitor means
107, 116, 403, 411 circuit switch communication means
108, 117, 404, 412 packet switch communication means
109, 413, 603 user information management server
110 user information management server overall control means
111 subscribed service utilization information acquirement means
112 user subscribed service utilization information DB
113 communication means
114, 604 communication server
115 communication server overall control means
118, 409 multimedia transmissions service providing method deciding means
119, 410 contents information DB
120, 418, 606 mobile network
401 first communication terminal
402 first communication terminal overall control means
405 multimedia transmission service response means
406 second communication terminal
407 second communication terminal overall control means
602 multimedia transmission service request message preparing means
605 multimedia transmission service providing method deciding/changing means

### DETAILED DESCRIPTION OF PREFERRED EMBODIMENTS

Hereinafter, embodiments of the present invention will be explained in detail with reference to drawings.

### Embodiment 1

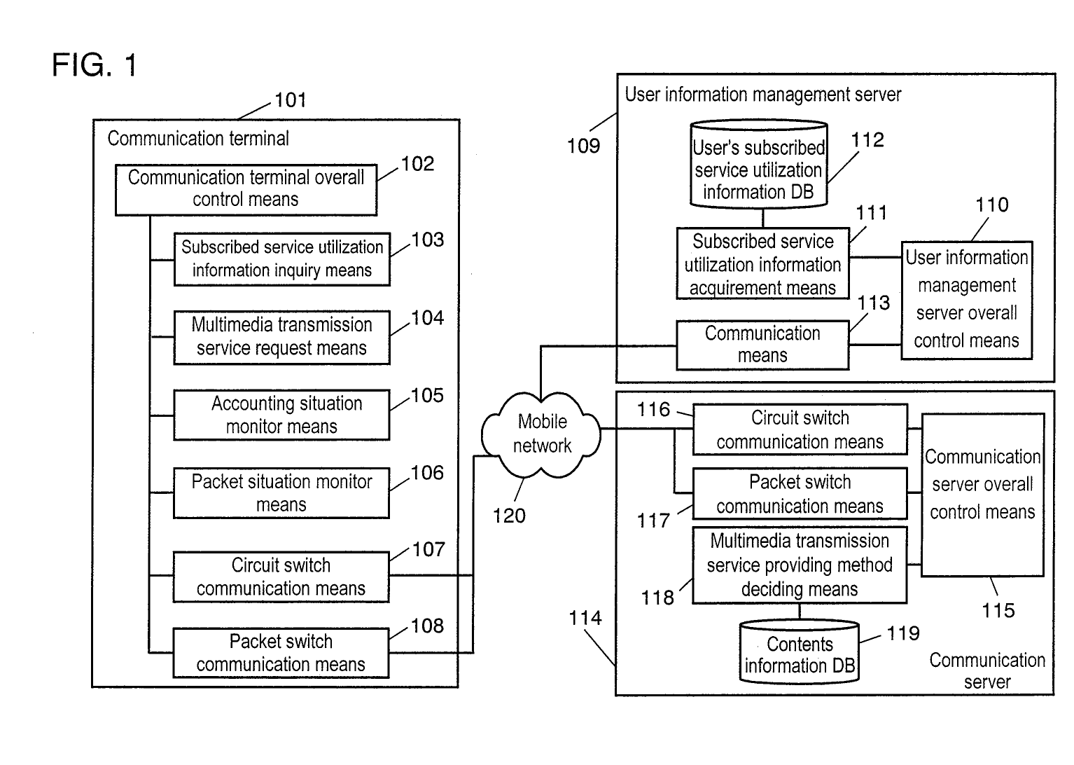

FIG. 1 is a block diagram which shows a configuration of a communication system in embodiment 1 of the present invention.

First, a configuration of a communication system in embodiment 1 will be explained in view of FIG. 1.

A communication system shown in FIG. 1 is configured by coupling communication terminal 101 as a communication apparatus which is used by a user, user information management server 109 which manages information of carrier services subscribed by a user, and communication server 114 which provides various multimedia transmission services through mobile network 120 as a communication medium.

That is, in this embodiment, a multimedia transmission service providing device comprises user information management server 109 and communication server 114.

Communication terminal 101 has communication terminal overall control means 102, subscribed service utilization information inquiry means 103, multimedia transmission service request means 104, accounting situation monitor means 105 and packet situation monitor means 106, circuit switch communication section (hereinafter, described as circuit switch communication means) 107 and packet switch communication section (hereinafter, described as packet switch communication means) 108.

Communication terminal overall control means 102 fully controls subscribed service utilization information inquiry means 103, service request means 104, accounting situation monitor means 105, packet situation monitor means 106, circuit switch communication means 107 and packet switch communication means 108.

Subscribed service utilization information inquiry means 103 configures a service utilization information procurement section which procures service utilization information regarding user's utilization of mobile network 120, and inquires carrier service utilization information of user's communication terminal 101 subscribed to the carrier service, from user information management server 109, by use of packet switch communication means 108.

Service request means 104 as a multimedia transmission service request section transmits a multimedia transmission service request or a service change request, to communication server 114, by use of packet switch communication means 108.

Accounting situation monitor means 105 as a part of a communication situation monitor section gets hold of an accounting situation, by monitoring communication by circuit switch communication means 107 and packet switch communication means 108.

Likewise, packet situation monitor means 106 as a part of a communication situation monitor section gets hold of a packet situation, by monitoring packet communication by packet switch communication means 108.

Circuit switch communication means 107 as a part of a communication section is coupled to mobile network 120 and carries out communication by circuit switch.

Likewise, packet switch communication means 108 as a part of a communication section is coupled to mobile network 120 and carries out communication by packet switch.

Mobile network 120 is configured by a mobile public network such as W-CDMA (Wideband-Code Division Multiple Access), PDC (Personal Digital Cellular), and GSM (Global System for Mobile Communication).

User information management server 109 has user information management server overall control means 110, subscribed service utilization information acquirement means 111, user's subscribed service utilization information DB 112 and communication means 113.

User information management server overall control means 110 fully controls subscribed service utilization information acquirement means 111 and communication means 113.

Subscribed service utilization information acquirement means 111 acquires subscribed service utilization information of a specified user, from user's subscribed service utilization information DB (Data Base) 112 in which user subscribed service utilization information has been accumulated.

Communication means 113 is coupled to mobile network 120, and carries out communication by circuit switch or packet switch.

Communication server 114 has communication server overall control means 115, circuit switch communication section (hereinafter, described as circuit switch communication means) 116, packet switch communication section (hereinafter, described as packet switch communication means) 117, multimedia transmission service providing method deciding means 118 and contents information DB 119.

Communication server overall control means 115 fully controls circuit switch communication means 116, packet switch communication means 117 and service providing method deciding means 118.

Circuit switch communication means 116 as a part of a communication section is coupled to mobile network 120 and carries out communication by circuit switch.

Likewise, packet switch communication means 117 as apart of a communication section is coupled to mobile network 120 and carries out communication by packet switch.

Service providing method deciding means 118 as a multimedia transmission method deciding section decides a method of providing service to a user from contents information DB 119 as a transmission information storage section in which multimedia information such as video and audio has been stored.

In this embodiment, the multimedia transmission section is configured mainly by contents information DB 119.

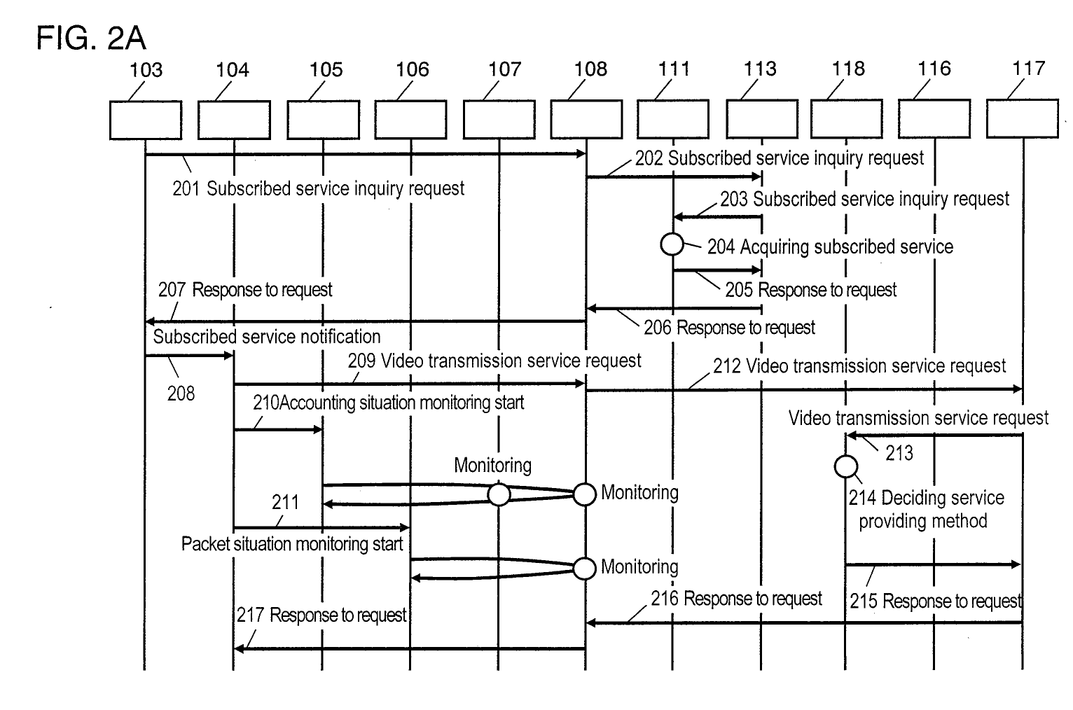

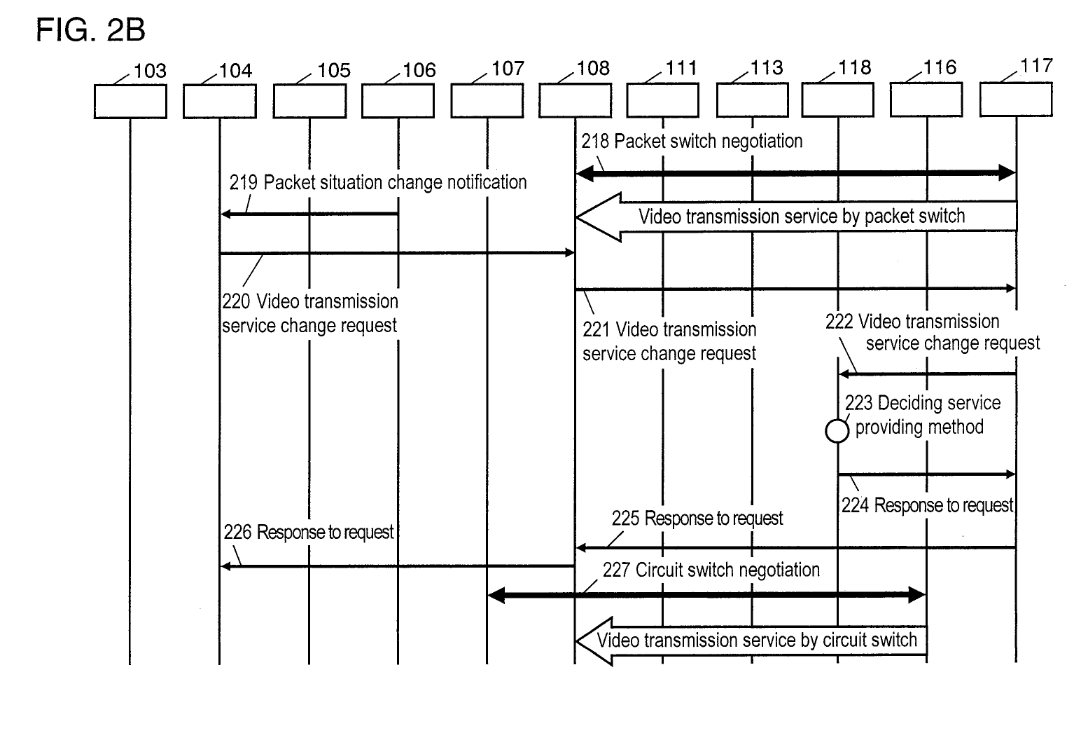

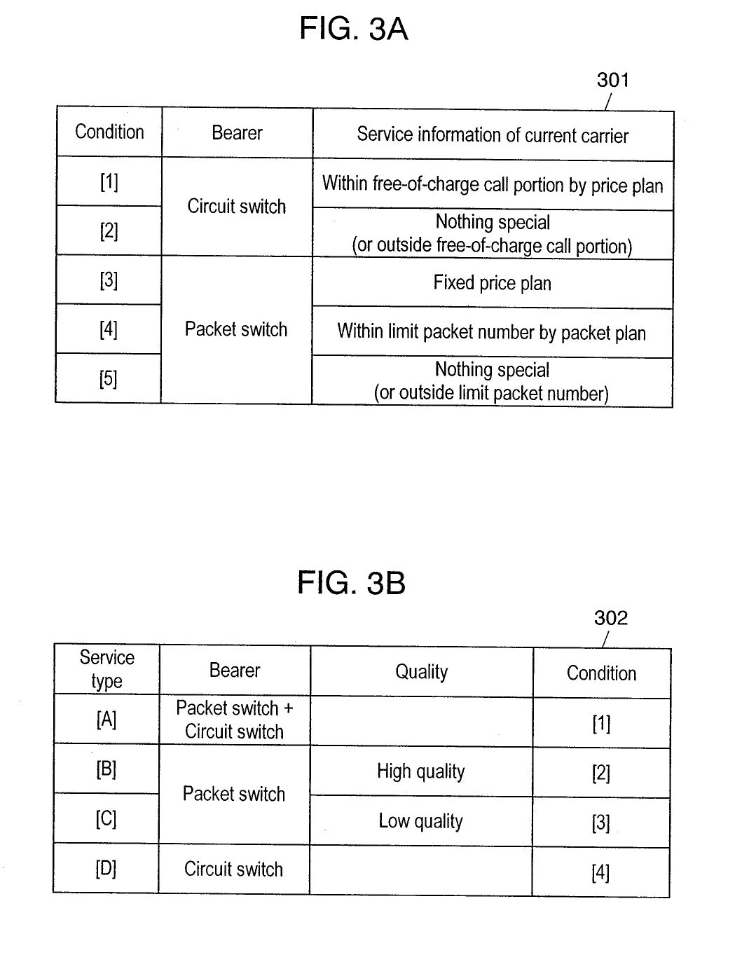

Secondly, an operation of the communication system in FIG. 1 will be explained by use of a sequence chart of FIG. 2 and a data format view of FIG. 3

This embodiment will explain such a case that a video transmission service is treated as a multimedia transmission service, and excess of limit packet number is used as a threshold value for transmitting a video transmission service change request which requests for a change of a providing method this video transmission service, and the providing method is changed from a video transmission service by packet switch to a video transmission service by circuit switch.

In FIG. 2, the following operation is carried out by control of communication terminal overall control means 102, in communication terminal 101 (hereinafter, an explanation about more detailed operation of communication terminal overall control means 102 itself will be omitted).

When subscribed service utilization information inquiry means 103 outputs an instruction of subscribed service inquiring request 201 to packet switch communication means 108, packet switch communication means 108 transmits subscribed service inquiring request 202 to communication means 113 of user information management server 109.

In user information management server 109, the following operation is carried out by control of user information management server overall control means 110 (hereinafter, an explanation about more detailed operation of user information management server overall control means 110 itself will be omitted).

Communication means 113 receives a subscribed service inquiring request, and outputs subscribed service inquiring request 203 to subscribed service utilization information acquirement means 111.

Subscribed service utilization information acquirement means 111 acquires user's subscribed service utilization information from user subscribed service utilization information DB 112 (shown as acquiring subscribed service 204 in FIG. 2A), and transmits response to request 205 to communication means 113.

After receiving this response 205, communication means 113 transmits response to request 206 to packet switch communication means 108 of communication terminal 101.

Subscribed service utilization information, which is acquired here, is service utilization information of a carrier to which a user subscribes, and indicates every personal information regarding accounting/packets such as a price plan, a packet plan, remaining free-of-charge talking time, and monthly accounting time.

Subscribed service utilization information inquiry means 103 of communication terminal 101 receives response to request 207 through packet switch communication means 108 in response to subscribed service inquiry request 201, and notifies subscribed service notification 208 to service request means 104.

A user decides quality/bearer of a video transmission service on the basis of a result of subscribed service notification 208 by service request means 104, and service request means 104 outputs transmission service request 209 to packet switch communication means 108, and packet switch communication means 108 transmits video transmission service request 212 to packet switch communication means 117 of communication server 114.

Here will be noted that decision of quality/bearer of a video transmission service requested by a user is carried out on the basis of current information regarding accounting/packet of a user, and a type of a video transmission service which communication server 114 provides. It is assumed that communication terminal 101 has already recognized the type of a video transmission service which is provided by communication server 114, by a user inquiring to communication server 114 in advance, or by some other means.

FIGS. 3A and 3B are views which show one example of a data format that is utilized for decisions of quality/bearer etc. of a video transmission service. Data configuration 301 in FIG. 3A is a data format in which various service utilization information of a carrier is organized with respect to each bearer, and sets up a condition number with respect to each combination of carrier's service utilization information and a bearer.

Data format 302 in FIG. 3B is a data format for deciding which bearer's service is selected out of types of video transmission services which communication server 114 provides, on the basis of conditions derived from data format 301, and for example in case that a situation of a user falls under condition [4] of data configuration 301, type [C] of a video transmission service is to be selected.

A user selects quality and a bearer which are desired to be provided, from data configurations 301, 302 shown in FIG. 3A and FIG. 3B, respectively. This embodiment will be explained on such an assumption that service type [C] (i.e. packet switch: low quality) is selected as an initial condition.

Returning to FIG. 2, communication server 114 carries out the following operation by control of communication server overall control means 115 (hereinafter, more detailed explanation of an operation of communication server overall control means 115 itself will be omitted).

Packet switch communication means 117 receives video transmission service request 212, and outputs video transmission service request 213 to service providing method deciding means 118.

Service providing method deciding means 118 decides a video transmission service which is provided from contents information DB 119, on the basis of quality/bearer information shown in FIG. 3B which is attached to video transmission service request 213 (shown as deciding service providing method 214 in FIG. 2A), and outputs the decided content to packet switch communication means 117 as response to request 215.

Then, packet switch communication means 117 transmits response to request 216 to packet switch communication means 108 of communication terminal 101.

In communication terminal 101, packet switch communication means 108 receives response to request 216 in response to video transmission service request 212, by packet switch communication means 108, and outputs response to request 217 to service request means 104.

After that, a negotiation by packet switch is carried out between communication terminal 101 and communication server 114, and a video transmission service by packet switch is started. With regard to packet switch negotiation 218, any means can be used for it, and therefore, a detailed explanation will be omitted.

In the meantime, in communication terminal 101, after packet switch communication means 108 transmitted video transmission service request 212 to a communication server on the basis of transmission of video transmission service request 209 from service request means 104, service request means 104 outputs accounting situation monitoring start 210 to accounting situation monitor means 105 and packet situation monitoring start 211 to packet situation monitor means 106, respectively, and accounting situation monitor means 105 monitors circuit switch communication means 107 and packet switch communication means 108 to start monitoring of an accounting situation, and packet situation monitor means 106 monitors packet switch communication means 108 to start monitoring of a packet situation.

Accounting situation monitor means 105 and packet situation monitor means 106 compare a packet situation which arises from a video transmission service by packet switch with a threshold value based on subscribed service utilization information received from user information management server 109, e.g., a situation of receiving no benefit of a price plan due to increase of packet number (a situation in which a free-of-charge call has run out, etc.). In case that a packet situation of a video transmission service by packet switch has exceeded this threshold value, in communication terminal 101, packet situation monitor means 106 outputs packet situation change notification 219 to service request means 104.

Service request means 104 judges, on the basis of data format 301 shown in FIG. 3A, a situation in which it has exceeded a limit packet number by a packet plan and has exceeded a free-of-charge call, i.e., judges that a condition has changed from [4] to [2], and selects type [D] (i.e. circuit switch) of a video transmission service, on the basis of data format 302 shown in FIG. 3B. Multimedia transmission service request means 104 transmits video transmission service change requests 220, 221 from [C] to [D], to communication server 114, through packet switch communication means 108.

Then, communication server 114 receives video transmission service change request 221 by packet switch communication means 117, and carries out video transmission service change request 222 to service providing method deciding means 118. Service providing method deciding means 118 decides a video transmission service to be changed, from contents information DB 119, on the basis of quality/bearer information shown in FIG. 3B which is attached to video transmission service request 222 (shown as deciding service providing method 223 in FIG. 2B), and transmits responses to request 224 and 225 to communication terminal 101 through packet switch communication means 117.

Service request means 104 of communication terminal 101 receives response to request 226 to video transmission service change request 220 through packet switch communication means 108.

After that, negotiation 227 by circuit switch is carried out between communication terminal 101 and communication server 114, and a video transmission service by circuit switch is started. With regard to circuit switch negotiation 227, any means can be used for it, and therefore, a detailed explanation will be omitted.

As above, in embodiment 1, communication terminal 101 gets hold of an accounting situation/a packet situation of an individual user, on the basis of various subscribed service utilization information which is provided by a carrier, and monitors accounting/packet situations which change dynamically, on the basis of this information, and thereby, it becomes possible to select or change to a video transmission service which is optimum to a user, out of video transmission services by various bearers.

This embodiment explained about a change from a video transmission service by packet switch to a video transmission service by circuit switch, but it is possible to change from a multimedia transmission service of a certain bearer (or quality) to a multimedia transmission service of a different bearer (or quality).

Further, in this embodiment, subscribed service utilization information is classified into five conditions such as data format 301, and a request or a change request of a video transmission service was carried out in accordance with applicable conditions, but it is all right even if it is configured so as to change a data format from which suchlike conditions are derived, on the occasion of a future change of a subscribed service, and to select or change to a multimedia transmission service which is optimum to a user, out of multimedia transmission services by various bearers.

Further, in this embodiment, an accounting situation and a packet situation were monitored and a request or a change request of a video transmission service was carried out depending on its change, but it is all right even if it is configured so as to monitor, on the occasion of a change of a change condition of a data format from which a multimedia transmission service request or a change request is derived, a situation which has matched with that change condition.

Further, this embodiment has described video transmission services which are provided by various bearers, but it is possible to apply it to not only video transmission services but also multimedia transmission service using various bearers commencing with an audio service.

This embodiment has described a case of providing a video transmission service from communication server 114 to communication terminal 101, but by making another communication terminal hold the same configuration as that of a communication server, it is possible to provide a multimedia transmission service from this communication terminal having the same configuration as that of a communication server to, for example, communication terminal 101 which receives a service in this embodiment, and to obtain the same advantages as those in this embodiment.

Furthermore, this embodiment treats only about an one-way as a flow of communication between terminals, providing a video transmission service from a service providing side communication terminal to a service receiving side communication terminal, but by adding a configuration of the service receiving side communication terminal in the service providing side communication terminal and adding a configuration of the service providing side communication terminal in the service receiving side communication terminal, it is possible to provide a interactive multimedia transmission service, in other words, a TV telephone and a voice telephone can be realized, and even in suchlike cases, it is possible to obtain the same advantages as those in this embodiment.

### Embodiment 2

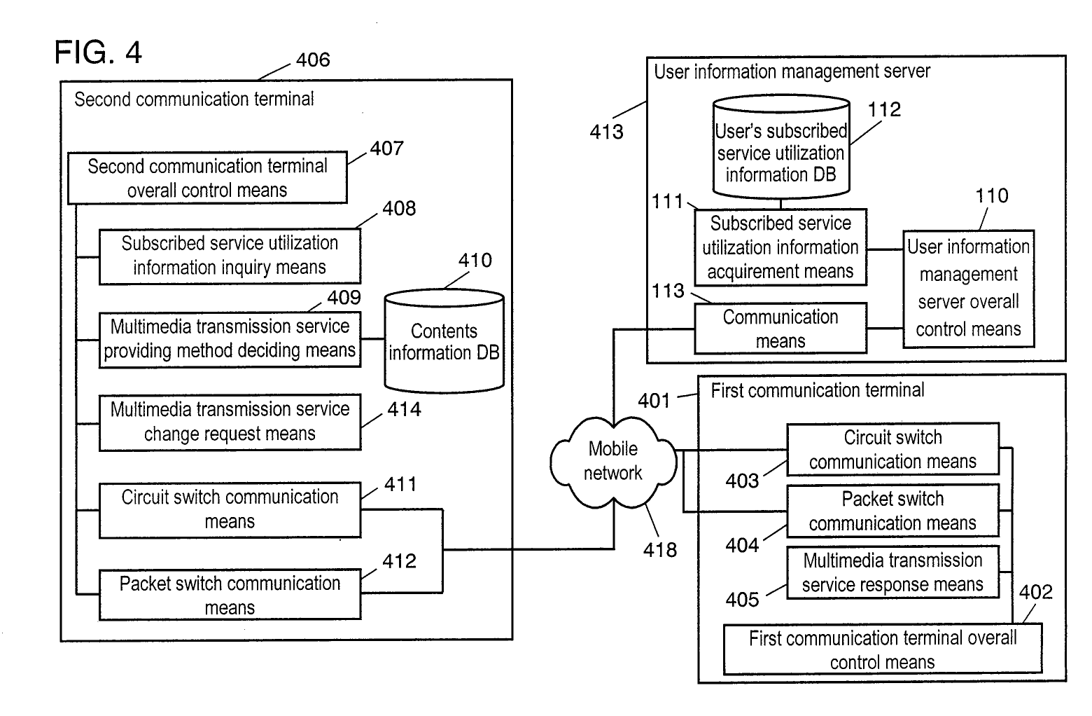

FIG. 4 is a block diagram which shows a configuration of a communication system in embodiment 2 of the present invention.

First, a configuration of a communication system in embodiment 2 will be explained in view of FIG. 4.

A communication system in this embodiment is configured by coupling first communication terminal 401 as a communication apparatus for a user who receives a service, user information management server 413 for carrier services subscribed by a user, and second communication server 406 as a communication apparatus which provides services, through mobile network 418 as a communication medium.

First communication terminal 401 has first communication terminal overall control means 402, circuit switch communication section (hereinafter, described as circuit switch communication means) 403 and packet switch communication section (hereinafter, described as packet switch communication means) 404 as communication sections, and multimedia transmission service response means 405 as a multimedia transmission service response section.

First communication terminal overall control means 402 fully controls circuit switch communication means 403, packet switch communication means 404 and multimedia transmission service response means 405.

Since more detailed operation of first communication terminal overall control means 402 is beyond the scope of this invention, it will be omitted in the following explanation.

Circuit switch communication means 403 is coupled to mobile network 408 and carries out communication by circuit switch.

Packet switch communication means 404 is coupled to mobile network 418 and carries out communication by packet switch.

Service response means 405 transmits a response message to a multimedia transmission service request, to second communication terminal 406, by use of packet switch communication means 404.

Second communication terminal 406 has second communication terminal overall control means 407, subscribed service utilization information inquiry means 408 as a service utilization information procurement section, multimedia transmission service providing method deciding means 409 as a multimedia transmission method deciding section, contents information DB 410 as a transmission information storage section, circuit switch communication section (hereinafter, described as circuit switch communication means) 411 and packet switch communication section (hereinafter, described as packet switch communication means) 412 as communication sections, and multimedia transmission service change request means 414.

Second communication terminal overall control means 407 fully controls subscribed service utilization information inquiry means 408, service providing method deciding means 409, circuit switch communication means 411, packet switch communication means 412, and service change request means 414.

Since more detailed operation of second communication terminal overall control means 407 is beyond the scope of this invention, it will be omitted in the following explanation.

Subscribed service utilization information inquiry means 408 inquires subscribed service utilization information of a carrier to which second communication terminal 406 subscribes, to user information management server 413, by use of packet switch communication means 412.

Service providing method deciding means 409 decides a method of providing a user with a service, from contents information DB 410 in which multimedia contents such as video and audio has been stored.

In addition, service providing method deciding means 409 performs a function of a communication situation monitor section which monitors an accounting situation which arises from use of circuit switch communication means 411 and packet switch communication means 412, and a use situation of packet switch communication means 412.

Circuit switch communication means 411 is coupled to mobile network 408 and carries out communication by circuit switch.

Packet switch communication means 412 is coupled to mobile network 418 and carries out communication by packet switch.

Service change request means 414 carries out a change request of a multimedia transmission service, to first communication terminal 401.

A configuration of user information management server 413 in FIG. 4 is identical to that of user information management server 109 in FIG. 1.

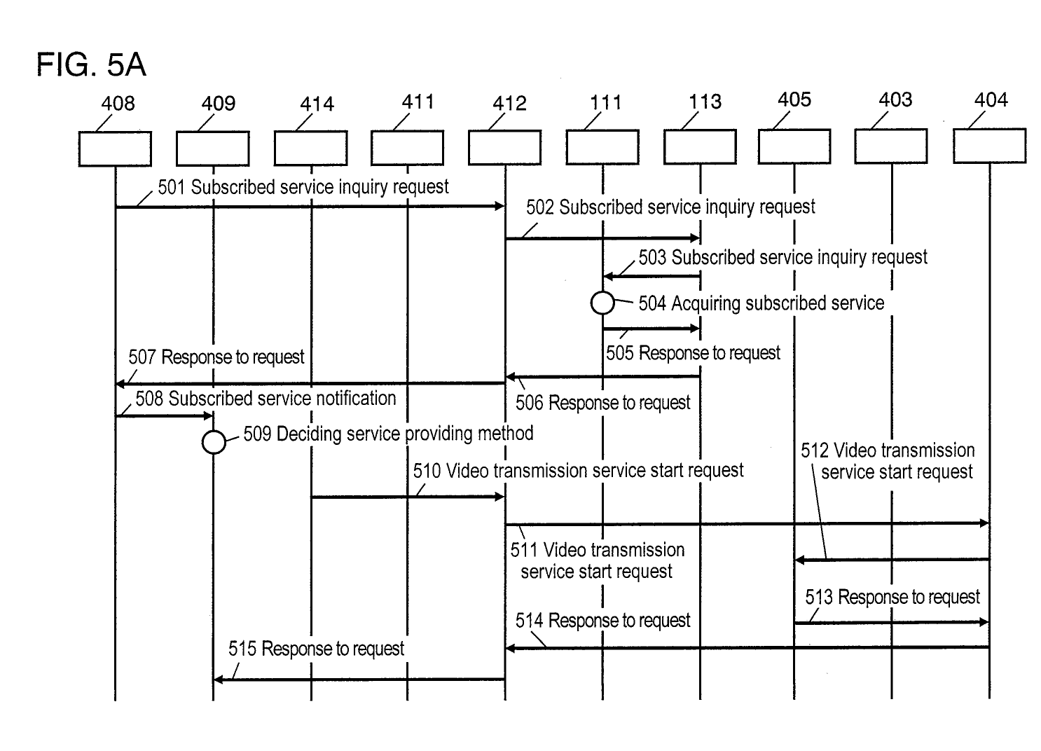

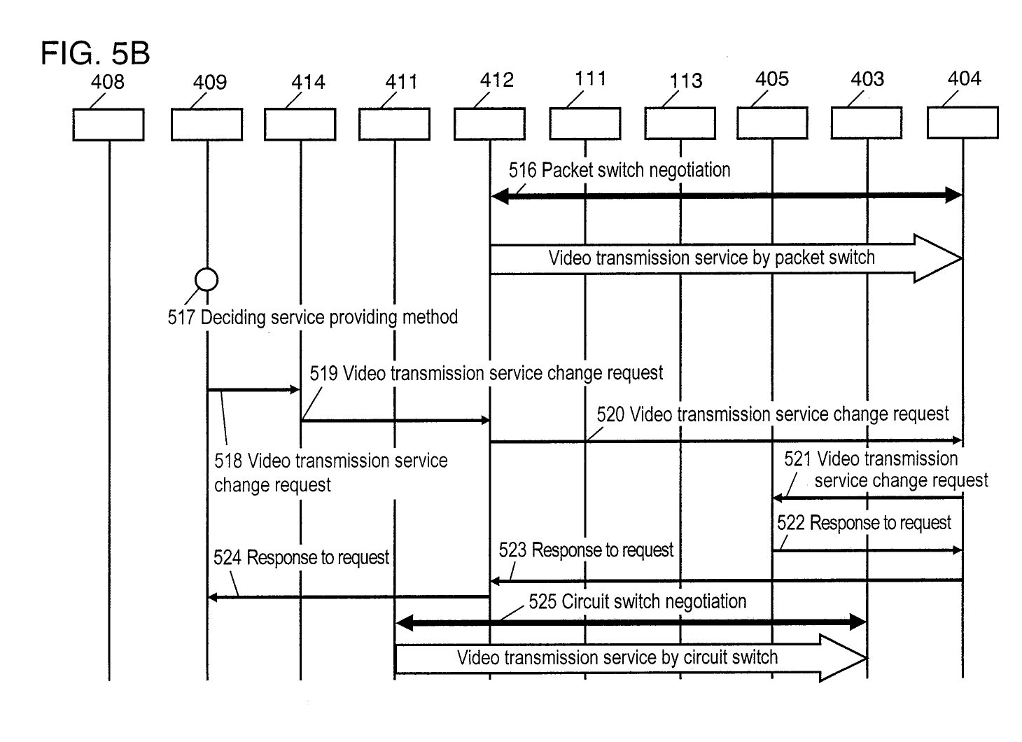

Secondly, an operation of a communication system in FIG. 4 will be explained by use of sequence charts of FIGS. 5A and 5B and data format views of FIGS. 3A and 3B.

This embodiment will explain such a case that a video transmission service is treated as a multimedia transmission service, and excess of limit packet number is used as a threshold value for carrying out a video transmission service change, to change from a video transmission service by packet switch to a video transmission service by circuit switch, in the same manner as in embodiment 1.

In FIG. 5A, a series of information flows of inquiring a service i.e. subscribed service inquiry request 501 through response to request 507 are the same as information flows of inquiring a service by subscribed information service inquiry request 201 through response to request 207 in FIG. 2, and therefore, an explanation of these information flows will be omitted.

Second communication terminal 406 notifies the received subscribed service utilization information to service providing method deciding means 409, as subscribed service notification 508 through subscribed service utilization information inquiry means 408.

Service providing method deciding means 409 decides quality/bearer of a video transmission service, on the basis of subscribed service notification 508 (shown as deciding service providing method 509), and outputs video transmission service start request 510 to packet switch communication means 412, and transmits video transmission service start request 511 to packet switch communication means 404 of first communication terminal 401.

Wherein, decision of quality/bearer etc. of a video transmission service, which is provided here, is carried out by information regarding user's current account and packet usage, and a type of a video transmission service which second communication terminal 406 provides.

FIGS. 3A and 3B show one example of a data format which is utilized for decision of quality/bearer etc. of a video transmission service, and it was already explained in embodiment 1, therefore an explanation will be omitted.

A user selects desired quality and bearer from the data format of FIGS. 3A and 3B. Hereinafter, it will be explained on such an assumption that service type [C] (i.e. packet switch: low quality) of FIG. 3B was selected in the same manner as in embodiment 1.

Returning to FIGS. 4, 5A and 5B, first communication terminal 401 receives video transmission service start request 511 by packet switch communication means 404, and outputs video transmission service start request 512 to service response means 405.

Service response means 405 transmits request responses 513 and 514 to packet switch communication means 412 of second communication terminal 406 through packet switch communication means 404, and packet switch communication means 412 outputs response to request 515 to service providing method deciding means 409.

After second communication terminal 406 receives response to request 514 of a video transmission service start request by packet switch communication means 412, negotiation 516 by packet switch is carried out between first communication terminal 401 and second communication terminal 406, and then a video transmission service by packet switch is started. That is, a video transmission service is provided from contents information DB 410 of second communication terminal 406 to the first communication terminal 401. With regard to packet switch negotiation 516, any means can be used for it, and therefore, a detailed explanation will be omitted.

Now, in second communication terminal 406, service providing method deciding means 409 monitors use situations of circuit switch communication means 411 and packet switch communication means 412, and compares the number of transmission packets which arises from a video transmission service by packet switch with a threshold value based on subscribed service utilization information received from user information management server 413, e.g., a situation of receiving no benefit of a price plan due to increase of packet number (a situation in which a free-of-charge call has run out, etc.), and in case that it has exceeded this threshold value, second communication terminal 406 decides service type [D] (i.e. circuit switch) from data format 301 and data configuration 302, by use of service providing method deciding means 409, in the same manner as in embodiment 1 (shown as deciding service providing method 517 in FIG. 5B).

When a service type is decided, service providing method deciding means 409 of second communication terminal 406 transmits video transmission service change requests 518, 519 and 520 to packet switch communication means 404 of first communication terminal 401 through service change means 414 and packet switch communication means 412.

First communication terminal 401 receives video transmission service change request 520 by packet switch communication means 404, and carries out video transmission service change request 521 to service response means 405.

Service response means 405 transmits responses to request 522 and 523 to packet switch communication means 412 of second communication terminal 406 through packet switch communication means 404.

Second communication terminal 406 receives response to request 523 of a video transmission service change request by packet switch communication means 412, and transmits response to request 524 to service providing method deciding means 409.

After that, negotiation 525 by circuit switch is carried out between first communication terminal 401 and second communication terminal 406, and a video transmission service by circuit switch is started. With regard to circuit switch negotiation 524, any means can be used for it, and therefore, a detailed explanation will be omitted.

As above, in this embodiment, second communication terminal 406 has a function of providing a multimedia transmission service, and it becomes possible to get hold of an accounting situation and a packet situation of an individual user, on the basis of various subscribed service utilization service information which is provided by a carrier, and to select or change to a video transmission service which is optimum to a user providing a video transmission service, out of video transmission services by various bearers, on the basis of this information.

That is, in case that second communication terminal 406 is, for example, a portable telephone and a personal image of an owner of a portable terminal, downloaded images, etc. have been stored in contents information DB 410, it is possible to transmit them to first communication terminal 401 by selecting or changing to an optimum video transmission service.

This embodiment explained about a change from a video transmission service by packet switch to a video transmission service by circuit switch, but it is possible to change from a multimedia transmission service of a certain bearer (or quality) to a multimedia transmission service of a different bearer (or quality).

Further, in this embodiment, subscribed service utilization information is classified into five conditions such as data format 301, and a request or a change request of a video transmission service was carried out in accordance with an applicable condition, but it is all right even if it is configured so as to change a data format from which suchlike conditions are derived, on the occasion of a future change of a subscribed service, and to select or change to a multimedia transmission service which is optimum to a user, out of multimedia transmission services by various bearers.

Further, this embodiment carries out a request or a change request of a video transmission service responsive to an accounting situation and a packet situation, but it is all right that it is configured so as to monitor, on the occasion of a change of a change condition of a data format from which a multimedia transmission service request or a change request is derived, a situation which has matched with that change condition.

In addition, in this embodiment, service providing method deciding means 409 monitors an accounting situation which arises from use of circuit switch communication means 411 and packet switch communication means 412, and a use situation of packet switch communication means 412, but the present invention is not limited to this, and it is also possible to change a video transmission service providing method, by monitoring an accounting situation which arises from use of circuit switch communication means 403 and packet switch communication means 404 of first communication terminal 401, and a use situation of packet switch communication means 404.

Further, this embodiment explained about video transmission services provided by various bearers, but it is possible to apply it not only video transmission services but also multimedia transmission services using various bearers commencing with an audio service.

Furthermore, this embodiment treats only an one-way communication between terminals, providing a video transmission service from the second communication terminal to the first communication terminal, but by adding a configuration of first communication terminal 401 in second communication terminal 406 and adding a configuration of second communication terminal 406 in first communication terminal 401, it is possible to provide a interactive multimedia transmission service, such as a TV telephone or a voice telephone, and even in suchlike cases, it is possible to obtain the same advantages as those in this embodiment.

### Embodiment 3

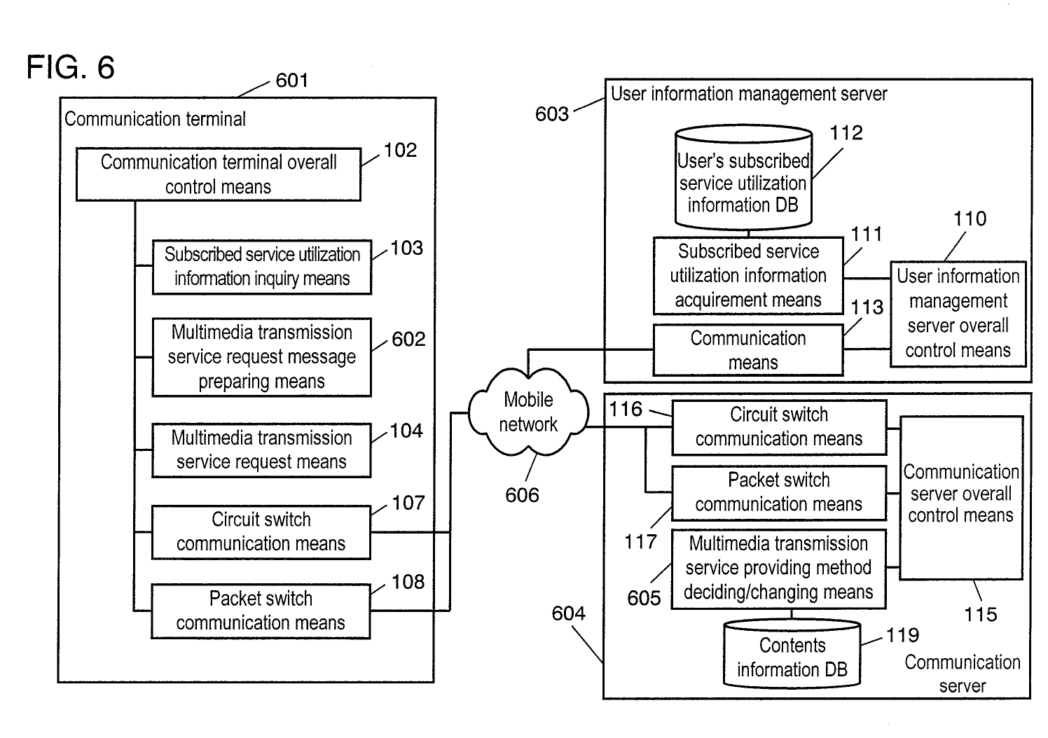

FIG. 6 is a block diagram which shows a configuration of a communication system in embodiment 3 of the present invention.

In FIG. 6, by using an identical reference numeral to a portion which is identical to that in FIG. 1, an explanation about it will be omitted except reference numeral 603.

First, a configuration of a communication system in embodiment 3 will be explained in view of FIG. 6.

Communication terminal 601 as a communication apparatus in FIG. 6 is different from communication terminal 101 shown in FIG. 1, on such a point that accounting situation monitor means 105 and packet situation monitor means 106 of communication terminal 101 shown in FIG. 1 are removed and multimedia transmission service request message preparing means 602 as a multimedia transmission service request condition preparing section is disposed.

Service request message preparing means 602 applies processing to a data format by adding availability information showing availability or conditionally availability of a service etc., to respective conditions of a circuit switching service and a packet switching service, on the basis of user's subscribed service utilization information which is acquired by subscribed service utilization information inquiry means 103 as a service utilization information procurement section.

Communication service 604 in FIG. 6 is different on such a point that multimedia transmission service providing method deciding/changing means 605 as a multimedia transmission method changing section is used in lieu of multimedia transmission service providing method deciding means 118 of communication server 114 in FIG. 1.

Service providing method deciding/changing means 605 decides a video transmission service which is provided to a user, and also changes a multimedia transmission service in tune with a service providing index of each user.

Further, service providing method deciding/changing means 605 also performs a function of a communication situation monitor section which monitors an accounting situation that arises from use of circuit switch communication means 116 and packet switch communication means 117, and a use situation of packet switch communication means 117.

User information management server 603 in FIG. 6 is identical to user information management server 109 in FIG. 1.

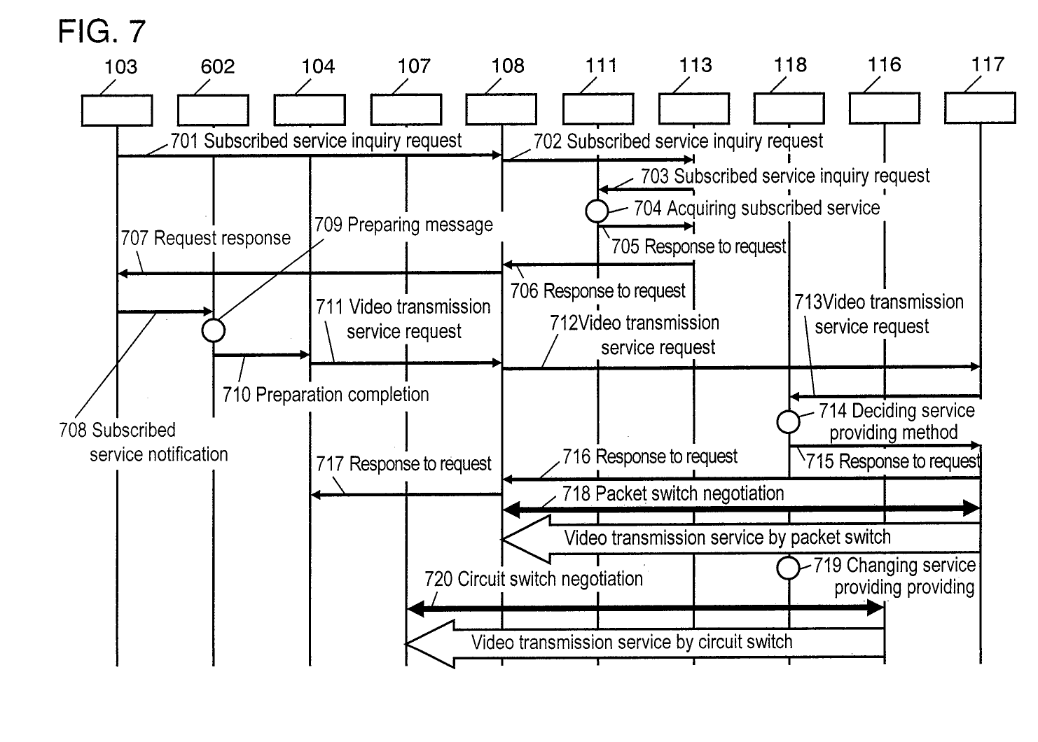

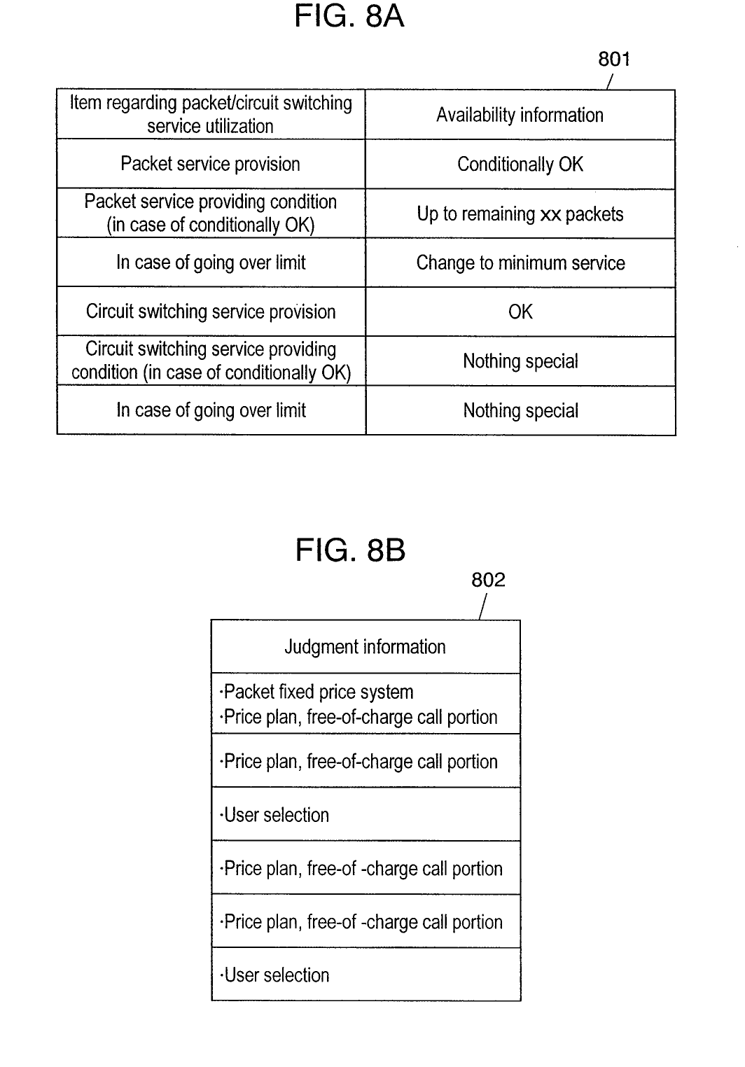

Secondly, an operation of a communication system in FIG. 6 will be explained by use of a sequence chart shown in FIG. 7 and a data format view of FIG. 8. In FIG. 6, an explanation will be carried out by applying e.g. a video transmission service for a multimedia transmission service, as in the same manner in embodiment 1.

In FIG. 7, a series of information flows of inquiring a subscribed information service i.e. subscribed service inquiry request 701 through response to request 707, are the same as information flows of subscribed information service inquiry request 201 through response to request 207 in FIG. 2, and therefore, an explanation of these information flows will be omitted.

Communication terminal 601 notifies the received subscribed service to service request message preparing means 602 (shown as notifying subscribed service 708 in FIG. 7), and service request message preparing means 602 processes subscribed service notification 708 into a data format which shows availability of a service or conditionally availability of a service etc., judging from its content, on respective conditions of a circuit switching service and a packet switching service (shown as preparing message 709 in FIG. 7), and outputs completed data to multimedia transmission service request means 104 (preparation completion 710). Service request means 104 transmits video transmission service requests 711 and 712 to packet switch communication means 117 of communication server 604, through packet switch communication means 108.

FIG. 8 shows an example of data format that is prepared at the point of preparing message 709 in FIG. 7.

Data format 801 shown in FIG. 8A is a data format that shows availability information such as availability or conditionally availability of a service etc. prepared from subscribed service utilization information, on respective conditions of a circuit switching service and a packet switching service.

Judgment information 802 shown in FIG. 8B is judgment information for deriving respective information elements of data format 801.

Hereinafter, assuming that a user “does not subscribe to a packet fixed price system but subscribed to a price plan in which an accounting coefficient is low up to certain predetermined packets, and a free-of-charge call portion remains” and by checking up the above-mentioned information with judgment information of FIG. 8B, it is set to “packet service provision: conditionally OK” from judgment information of “a packet fixed price system: not subscribed, a price plan: such a plan that an accounting coefficient is low up to certain predetermined packet number; and not yet reached up to that packets” and it is set to “packet service providing condition: up to remaining xx packets” from judgment information of “a price plan: an accounting coefficient is low, remaining xx packets up to certain predetermined packet number” and it is set to be information of “in case of going over the limit: change to a minimum service” by “user selection”, an explanation will be forwarded.

Communication server 604 receives video transmission service request 712 by packet switch communication means 117, and outputs video transmission service request 713 to service providing method deciding/changing means 605.

Service providing method deciding/changing means 605 decides a video transmission service which is provided from contents information DB 119, on the basis of data format 801 shown in FIG. 8A which is attached to video transmission service request 713 (shown as deciding service providing method 714 in FIG. 7), and transmits responses to request 715 and 716 to packet switch communication means 108 of communication terminal 601, through packet switch communication means 117.

Hereinafter, assuming that “packet service provision” was selected from data format 801, an explanation will be forwarded.

Communication terminal 601 receives response to request 716 responsive to video transmission service request 712, by packet switch communication means 108, and packet switch communication means 108 outputs response to request 717 to service request means 104.

After that, negotiation 718 by packet switch is carried out between communication terminal 601 and communication server 604, and a video transmission service by packet switch is started. With regard to packet switch negotiation 718, any means can be used for it, and therefore, a detailed explanation will be omitted.

In communication server 604, service providing method deciding/changing means 605 is monitoring an accounting situation which arises from use of circuit switch communication means 116 and packet switch communication means 117, and a use situation of packet switch communication means 117, and in case that a use situation of packet switch communication section 117 has reached to a packet number shown in data format 801 of FIG. 8A, service providing method deciding/changing means 605 judges it, and carries out a change to a video transmission service by circuit switch (shown as changing service providing method 719 in FIG. 7).

As a method of knowing that it has reached to the packet number which is a threshold value, conversion from a bit rate and transmission time of video contents, integration by monitoring transmitted TCP/IP (UDP/IP) packets, and so on are conceivable, but here, any means can be used for it, and therefore, a detailed explanation will be omitted.

After that, negotiation 720 by circuit switch is carried out between communication terminal 601 and communication server 604, and a video transmission service by circuit switch is started. With regard to circuit switch negotiation 720, any means can be used for it, and therefore, a detailed explanation will be omitted.

As above, in this embodiment, communication terminal 601 applies processing to a data format which shows availability or conditionally availability etc. of a service, to respective indexes of a circuit switching service and a packet switching service, on the basis of utilization information for various subscribed services which a carrier provides, attaches the data to a video transmission service request, transmits the request as a message, and then communication server 604 selects a video transmission service to be provided, on the basis of the request, and thereby, it becomes possible to select or change to a video transmission service which is optimum to a user, out of video transmission services by various bearers.

This embodiment explains about a change from a video transmission service by packet switch to a video transmission service by circuit switch, but it is also possible to change from a multimedia transmission service of a certain bearer (or quality) to a multimedia transmission service of a different bearer (or quality).

Further, in this embodiment, by making subscribed service utilization information to be in the form of a data format like 801 in FIGS. 8A and 8B, it is used as an index of a request or a change request of a video transmission service, but, it is all right even if it is configured so as to change a data format on the occasion of a future change of a subscribed service, and so as for a communication server to select or change to a video transmission service which is optimum to a user, out of video transmission services by various bearers, on the basis of that dataformat.

In addition, in this embodiment, service providing method deciding/changing means 605 monitors a use situation of circuit switch communication means 116 and packet switch communication means 117, but the present invention is not limited to this, and it is also possible to monitor a use situation of circuit switch communication means 107 and packet switch communication means 108 of communication terminal 601 to change a video transmission service providing method.

Further, this embodiment explains about video transmission services which are provided by various bearers, but it is possible to be applied to not only video transmission services but also to multimedia transmission service using various bearers commencing with an audio service.

This embodiment treats a case of providing a video transmission service from communication server 604 to communication terminal 601, but by making a certain communication terminal hold the same configuration as that of communication server 604, it is possible for a multimedia transmission service to be provided from the communication terminal having the same configuration as that of this communication server to communication terminal 601 which receives a service in this embodiment, and to obtain the same advantages as those in this embodiment.

Further, this embodiment treats only an one-way communication between terminals, providing a video transmission service from a service providing side communication terminal to a service receiving side communication terminal, but by adding a configuration of the service receiving side communication terminal in the service providing side communication terminal and adding a configuration of the service providing side communication terminal in the service receiving side communication terminal, it is possible to provide a interactive multimedia transmission service, in other words, a TV telephone and a voice telephone can be realized, and even in such cases, it is possible to obtain the same advantages as those in this embodiment.

### INDUSTRIAL APPLICABILITY

The present invention is useful as a communication terminal for displaying videos with various contents and/or generating sounds on portable electronic devices such as a portable telephone, PDF, a car navigation device, a portable TV and a portable radio, and a transmission server for transmitting videos and sounds with various contents to an portable electronic device.

1. A communication apparatus comprising:
a service utilization information procurement section which procures service utilization information regarding user's utilization of a communication medium, on the occasion of receiving provision of a multimedia transmission service through the communication medium;
a communication section which carries out communication with a multimedia transmission service providing device which provides the multimedia transmission service through the communication medium;
a communication situation monitor section which monitors a use situation of the communication section; and
a multimedia transmission service request section which requests for provision of the multimedia transmission service, to the multimedia transmission service providing device, on the basis of the service utilization information procured by the service utilization information procurement section or result information monitored by the communication situation monitor section.

2. The communication apparatus of claim 1, wherein the multimedia transmission service providing device has a user information management server which manages service utilization information regarding user's utilization of the communication medium and supplies the service utilization information to the service utilization information procurement section, and a communication server which carries out provision of the multimedia transmission service, responsive to a request from the multimedia transmission service request section.

3. The communication apparatus of claim 1, wherein the multimedia transmission service providing device has a user information management server which manages service utilization information regarding user's utilization of the communication medium and supplies the service utilization information to the service utilization information procurement section, and another communication device which carries out provision of the multimedia transmission service, responsive to a request from the multimedia transmission service request section.

4. The communication apparatus of claim 1, wherein the communication section has a packet switch communication section which is coupled to the communication medium and carries out communication by packet switch, and a circuit switch communication section which is coupled to the communication medium and carries out communication by circuit switch.

5. The communication apparatus of claim 4, wherein the communication situation monitor section monitors an accounting situation which arises from use of the packet switch communication section or the circuit switch communication section, or a packet use situation which arises from use of the packet switch communication section.

6. The communication apparatus of claim 5, wherein the service utilization information is an accounting situation or a packet use situation of a user.

7. A communication apparatus comprising:
a multimedia transmission method deciding section which decides a method of providing a multimedia transmission service, on the basis of a multimedia transmission service request from another communication apparatus which requests for provision of a multimedia transmission service;
a multimedia transmission section which transmits the requested multimedia transmission service to another communication apparatus through a communication medium by a multimedia transmission method which is decided by the multimedia transmission method deciding section; and
a communication section which carries out communication with another communication apparatus through the communication medium.

8. The communication apparatus of claim 7, wherein the multimedia transmission service request from another communication apparatus includes a request for changing a method of providing the multimedia transmission service, which is requested depending on a use situation of a communication section in another communication apparatus.

9. The communication apparatus of claim 7, wherein the multimedia transmission section has a transmission information storage section which stores transmission information to be transmitted, and the transmission information, which has stored in the information storage section, is transmitted to another communication apparatus through the communication section and the communication medium.

10. The communication apparatus of claim 7, wherein the communication section has a packet switch communication section which is coupled to the communication medium and carries out communication by packet switch, and a circuit switch communication section which is coupled to the communication medium and carries out communication by circuit switch.

11. The communication apparatus of claim 8, wherein another communication apparatus has a communication situation monitor section which monitors a use situation of the communication section in another communication apparatus, and the multimedia transmission service request is requested depending on a monitored result at the communication situation monitor section.

12. The communication apparatus of claim 7, wherein another communication apparatus has a service utilization information procurement section which procures service utilization information regarding user's utilization of the communication medium, on the occasion of receiving provision of the multimedia transmission service through the communication medium, and the multimedia transmission service request is requested on the basis of the service utilization information which is procured by the service utilization information procurement section.

13. The communication apparatus of claim 8, wherein another communication apparatus has a packet switch communication section which is coupled to the communication medium and carries out communication by packet switch, and a circuit switch communication section which is coupled to the communication medium and carries out communication by circuit switch.

14. The communication apparatus of claim 11, wherein another communication section has a packet switch communication section which is coupled to the communication medium and carries out communication by packet switch, and a circuit switch communication section which is coupled to the communication medium and carries out communication by circuit switch, and the communication situation monitor section monitors an accounting situation which arises from use of the packet switch communication section or the circuit switch communication section, or a packet use situation which arises from use of the packet switch communication section.

15. The communication apparatus of claim 12, wherein another communication section has a packet switch communication section which is coupled to the communication medium and carries out communication by packet switch, and a circuit switch communication section which is coupled to the communication medium and carries out communication by circuit switch, and the communication situation monitor section monitors an accounting situation which arises from use of the packet switch communication section or the circuit switch communication section, or a packet use situation which arises from use of the packet switch communication section, and the service utilization information is the accounting situation or the packet use situation of the user.

16. A communication apparatus comprising:
a service utilization information procurement section which procures service utilization information regarding user's utilization of a communication medium, on the occasion of providing a multimedia transmission service to another communication apparatus through the communication medium;
a communication section which carries out communication with another communication apparatus through the communication medium;
a communication situation monitor section which monitors a use situation of the communication section;
a multimedia transmission method deciding section which decides a method of providing the multimedia transmission service, on the occasion of providing the multimedia transmission service to another communication apparatus; and
a multimedia transmission service change request section which requests for a change of the method of providing the multimedia transmission service, to another communication apparatus, on the basis of result information monitored by the communication situation monitor section.

17. The communication apparatus of claim 16, wherein the communication section has a packet switch communication section which is coupled to the communication medium and carries out communication by packet switch, and a circuit switch communication section which is coupled to the communication medium and carries out communication by circuit switch.

18. The communication apparatus of claim 17, wherein the communication situation monitor section monitors an accounting situation which arises from use of the packet switch communication section or the circuit switch communication section, or a packet use situation which arises from use of the packet switch communication section.

19. The communication apparatus of claim 18, wherein the service utilization information is the accounting situation or the packet use situation of a user.

20. A communication apparatus comprising:
a service utilization information procurement section which procures service utilization information regarding user's utilization of a communication medium, on the occasion of receiving provision of a multimedia transmission service through the communication medium;
a multimedia transmission service request condition preparing section which prepares a request condition of the multimedia transmission service which is provided, on the basis of service utilization information procured by the service utilization information procurement section;
a multimedia transmission service request section which transmits the request condition prepared by the multimedia transmission service condition preparing section to another communication apparatus that provides the multimedia transmission service; and
a communication section which carries out communication with another communication apparatus through the communication medium.

21. The communication apparatus of claim 20, wherein the communication section has a packet switch communication section which is coupled to the communication medium and carries out communication by packet switch, and a circuit switch communication section which is coupled to the communication medium and carries out communication by circuit switch.

22. The communication apparatus of claim 21, wherein another communication apparatus monitors an accounting situation which arises from use of the packet switch communication section or the circuit switch communication section, or a packet use situation which arises from use of the packet switch communication section.

23. The communication apparatus of claim 22, wherein the service utilization information is the accounting situation or the packet use situation of a user.

24. A communication apparatus comprising:
a multimedia transmission method deciding section which decides a method of providing the multimedia transmission service, on the basis of a multimedia transmission service request from another communication apparatus which requests for provision of the multimedia transmission service;
a multimedia transmission section which transmits the requested transmission information to be transmitted, to another communication apparatus, through a communication medium, by using a multimedia transmission method decided by the multimedia transmission method deciding section;
a communication section which carries out communication with another communication apparatus through the communication medium;
a communication situation monitor section which monitors a use situation of the communication section; and
a multimedia transmission method changing section which changes a method of providing the multimedia transmission service, depending on the multimedia transmission service request, on the basis of result information monitored by the communication situation monitor section.

25. The communication section of claim 24, wherein the communication section has a packet switch communication section which is coupled to the communication medium and carries out communication by packet switch, and a circuit switch communication section which is coupled to the communication medium and carries out communication by circuit switch.

26. The communication apparatus of claim 25, wherein the communication situation monitor section monitors an accounting situation which arises from use of the packet switch communication section or the circuit switch communication section, or a packet use situation which arises from use of the packet switch communication section.

27. The communication apparatus of claim 24, wherein another communication apparatus has a service utilization information procurement section which procures service utilization information regarding user's utilization of a communication medium, on the occasion of receiving provision of the multimedia transmission service through the communication medium, and the multimedia transmission service request is requested on the basis of the service utilization information procured by the service utilization information procurement section.

28. The communication apparatus of claim 27, wherein the communication section has a packet switch communication section which is coupled to the communication medium and carries out communication by packet switch, and a circuit switch communication section which is coupled to the communication medium and carries out communication by circuit switch, and the communication situation monitor section monitors an accounting situation which arises from use of the packet switch communication section or the circuit switch communication section, or a packet use situation which arises from use of the packet switch communication section, and the service utilization information is the accounting situation or the packet use situation of a user.
